(19) United States
(12) Patent Application Publication
(10) Pub. No.: US 2026/0197633 A1
(43) Pub. Date: Jul. 9, 2026

(54) ACCESS POINT WITH PRIVACY ASSESSMENT

(71) Applicant: Cisco Technology, Inc., San Jose, CA (US)

(72) Inventors: Domenico FICARA, Essertines-Sur-Yverdon (CH); Ugo M. CAMPIGLIO, Morges (CH); Jerome HENRY, Pittsboro, NC (US); Javier I. CONTRERAS ALBESA, Sant Cugat del Valles (ES); Amine CHOUKIR, Ecublens (CH)

(21) Appl. No.: 19/281,657

(22) Filed: Jul. 26, 2025

Related U.S. Application Data
(60) Provisional application No. 63/743,523, filed on Jan. 9, 2025.

(51) Int. Cl. H04W 12/02; H04W 12/63

(52) U.S. Cl. CPC H04W 12/02; H04W 12/63

(57) ABSTRACT

Described herein is a network device that assesses privacy. The device includes one or more memories and one or more processors communicatively coupled to the one or more memories. The one or more processors, individually or collectively, perform an operation that includes determining usage statistics of a wireless medium for a group of user devices, determining that a first usage statistic of the usage statistics for a first user device of the group of user devices differs from a usage statistic of the usage statistics for other user devices of the group of user devices, and based on determining that the first usage statistic differs from the usage statistic for the other user devices, adjusting a transmission characteristic of the first user device such that the first usage statistics are brought closer to the usage statistics for the other user devices.

### CROSS-REFERENCE TO RELATED APPLICATIONS

This application claims benefit of co-pending United States provisional patent application Serial No. 63/743,523 filed January 9, 2025. The aforementioned related patent application is herein incorporated by reference in its entirety.

### TECHNICAL FIELD

Embodiments presented in this disclosure generally relate to wireless networks. More specifically, embodiments disclosed herein an access point in a wireless network that performs privacy assessment.

### BACKGROUND

Access points in wireless networks may implement various features to protect the privacy of devices on the networks. For example, the access points and devices may encrypt communications so that the content of the communications may not be determined by an intercepting device. As another example, the access points and devices may rotate media access control (MAC) addresses periodically so that it becomes more difficult for an intercepting device to determine which access point or device transmitted a message.

Some aspects of the communications between the access points and devices may still reveal which access point or device transmitted a message. For example, a device on the network may be transmitting using settings or properties (e.g., signal strength, bandwidth, transmission power, privacy enhancing features, etc.) that are different from the other devices on the network. As a result, messages transmitted by the device may be distinguishable from messages transmitted by other devices based on these settings or properties, which degrades the privacy of the device.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example access point or device in the system of FIG. 1A.

FIG. 2 illustrates an example operation performed by the system of FIG. 1A.

FIG. 3 illustrates an example adjustment in the system of FIG. 1A.

FIG. 4 is a flowchart of an example method performed by the system of FIG. 1A.

FIG. 5 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

The present disclosure describes a network device (e.g., access point, network controller, etc.) that assesses privacy. According to an embodiment, an apparatus includes one or more memories and one or more processors communicatively coupled to the one or more memories. The one or more processors, individually or collectively, perform an operation that includes determining usage statistics of a wireless medium for a group of user devices, determining that a first usage statistic of the usage statistics for a first user device of the group of user devices differs from a usage statistic of the usage statistics for other user devices of the group of user devices, and based on determining that the first usage statistic differs from the usage statistic for the other user devices, adjusting a transmission characteristic of the first user device such that the first usage statistics are brought closer to the usage statistics for the other user devices.

According to another embodiment, a method includes determining usage statistics of a wireless medium for a group of user devices, determining that a first usage statistic of the usage statistics for a first user device of the group of user devices differs from a usage statistic of the usage statistics for other user devices of the group of user devices, and based on determining that the first usage statistic differs from the usage statistic for the other user devices, adjusting a transmission characteristic of the first user device such that the first usage statistics are brought closer to the usage statistics for the other user devices.

According to another embodiment, a non-transitory computer readable medium stores instructions that, when executed by one or more processors, cause the one or more processors to, individually or collectively, perform an operation that includes determining usage statistics of a wireless medium for a group of user devices, determining that a first usage statistic of the usage statistics for a first user device of the group of user devices differs from a usage statistic of the usage statistics for other user devices of the group of user devices, and based on determining that the first usage statistic differs from the usage statistic for the other user devices, adjusting a transmission characteristic of the first user device such that the first usage statistics are brought closer to the usage statistics for the other user devices.

### EXAMPLE EMBODIMENTS

The present disclosure describes a network that determines whether the transmission characteristics of a device distinguish the device from other devices on the network. For example, an access point in the network may receive and analyze usage statistics of multiple devices on the network. These usage statistics may indicate the number of devices, the capabilities of the devices, the privacy features used by the devices, the signal strength of the devices, the bandwidth of the devices, the transmission powers of the devices, the channels used by the devices, the number of links used by the devices, etc. The access point may determine whether the usage statistics of a device are sufficiently different from the usage statistics of a large number of other devices such that the usage statistics of the device may reveal or distinguish the transmissions of the device from the transmissions of the other devices. The access point may then adjust the transmission characteristics of the device such that the usage statistics of the device are brought closer to the usage statistics of the other devices.

In certain embodiments, the network provides several technical advantages. For example, the network may improve the privacy of device transmissions on the network by making it more difficult to distinguish the transmissions of a device from the transmissions of other devices. As another example, the network may reduce the likelihood that an intercepting device may identify the transmissions of a device.

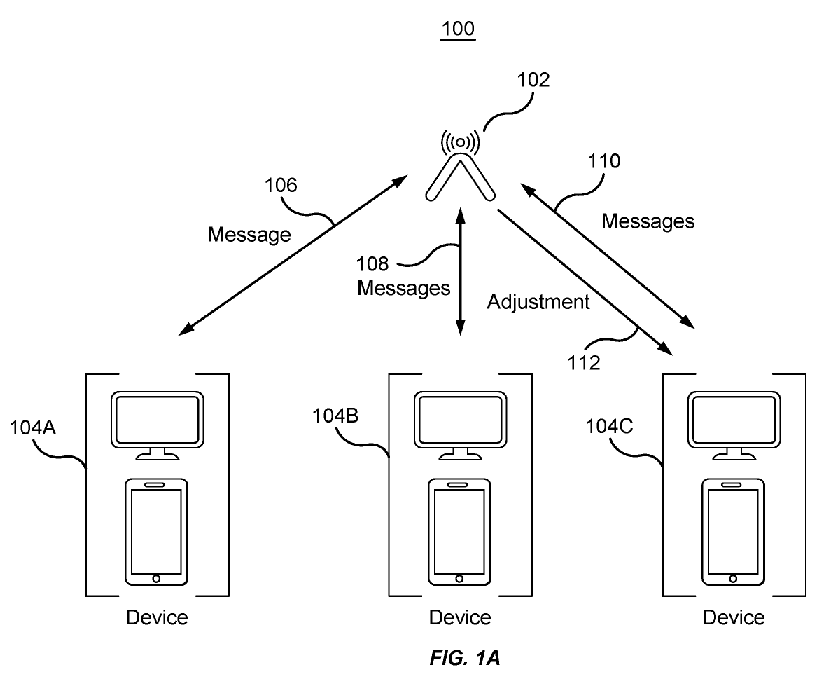

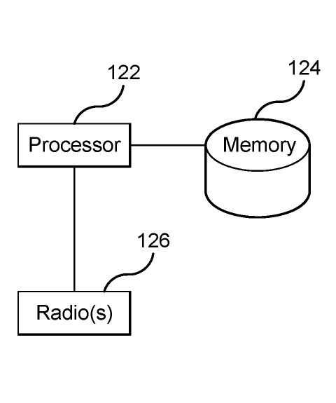

FIG. 1A illustrates an example system 100. As seen in FIG. 1A, the system 100 includes an access point 102 and a group of devices 104 (e.g., devices 104A, 104B, and 104C), which may also be referred to as user devices. Generally, the access point 102 determines whether the usage statistics of a device 104 differs sufficiently from the usage statistics of other devices such that the usage statistics of the device 104 may distinguish the transmissions of the device 104 from the transmissions from other devices, which may reduce the privacy of the device 104. In these situations, the access point 102 may adjust the usage statistics of the device 104 to bring the usage statistics closer to the usage statistics of other devices. As a result, it may be more difficult to determine the transmissions of the device 104.

The access point 102 may be a network device that facilitates wireless communication (e.g., Wi-Fi communication) in the system 100. The device 104 connects to the access point 102, and the access point 102 may facilitate communication to and from the device 104. For example, the access point 102 may receive messages from the device 104 and direct those messages towards their destination. As another example, the access point 102 may receive messages intended for the device 104 and direct those messages to the device 104. The access point 102 may also exchange messages with other access points 102.

The device 104 may be any suitable device that wirelessly connects to an access point 102. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

The access point 102 and the device 104 may implement various features to protect the privacy of the device 104. For example, the access point 102 and the device 104 may encrypt messages exchanged between the access point 102 and the device 104 so that it may be difficult to determine the content of the messages if the messages were intercepted. As another example, the access point 102 or the device 104 may periodically change or rotate a media control access (MAC) address of the access point 102 or device 104 so that it may be difficult to track which access point or device communicated the messages if the messages were intercepted.

In some instances, however, it may still be possible to determine that the messages were transmitted by or to the device 104. For example, the usage statistics of the device 104C may be sufficiently different from the usage statistics of the devices 104A and 104B. These usage statistics may indicate the number of devices, the capabilities of the devices, the privacy features used by the devices, the signal strength of the devices, the bandwidth of the devices, the transmission powers of the devices, the channels used by the devices, the number of links used by the devices, etc. As a result, it may be possible to identify the transmissions made by the device 104C because the transmissions were made according to usage statistics that are different from the usage statistics of the devices 104A and 104B.

The access point 102 may detect when the usage statistics of the device 104C are sufficiently different from the usage statistics of the devices 104A and 104B such that the transmissions of the device 104C are distinguishable from the transmissions of the devices 104A and 104B. The access point 102 may then adjust the usage statistics of the device 104C such that the usage statistics of the device 104C are brought closer to the usage statistics of the devices 104A and 104B, which may make it more difficult to distinguish the transmissions of the device 104C from the transmissions of the devices 104A and 104B.

The access point 102 transmits or receives messages from the devices 104. In the example of FIG. 1A, the access point 102 transmits or receives messages 106 to or from the device 104A. The access point 102 transmits or receives messages 108 to or from the device 104B. The access point 102 transmits or receives messages 110 to or from the device 104C. The messages 106, 108, and 110 may be transmitted or received according to the usage statistics of the devices 104A, 104B, and 104C. For example, the messages 106, 108, and 110 may be transmitted using different capabilities, privacy features, signal strengths, bandwidths, transmission powers, channels, links, etc. of the devices 104A, 104B, and 104C. If the usage statistics (e.g., transmission power) of the device 104C is sufficiently different from the usage statistics of the devices 104A and 104B, then it may be possible to determine the messages 110 were transmitted by the device 104C based on the different usage statistics.

The access point 102 may compare the usage statistics of the device 104C with the usage statistics of the devices 104A and 104B to determine how different the usage statistics of the device 104C are from the usage statistics of the devices 104A and 104B. If a difference between the usage statistics of the device 104C and the usage statistics of a device 104A or 104B exceed a threshold, then the access point 102 may determine that a transmission characteristic of the device 104C should be adjusted. The access point 102 may communicate one or more adjustments 112 to the device 104C. For example, the access point 102 may transmit a message that indicates the adjustment 112 to the device 104C. The device 104C may then make the adjustment 112, which may bring the usage statistics of the device 104C closer to the usage statistics of the device 104A or 104B.

As an example, the device 104C may transmit the messages 110 with a different signal strength, transmission power, bandwidth, channel, links, or privacy feature than the device 104A or 104B. The access point 102 may determine a difference between the signal strength, transmission power, bandwidth, channel, links, or privacy feature of the device 104C with the signal strength, transmission power, bandwidth, channel, links, or privacy feature of the device 104A or 104B. If this difference exceeds a threshold, the access point may communicate the adjustment 112 to the device 104C. The adjustment 112 may indicate an adjustment to the signal strength, transmission power, bandwidth, channel, links, or privacy feature of the device 104C. The device 104C may make the adjustment 112, which may bring the signal strength, transmission power, bandwidth, channel, links, or privacy feature of the device 104C closer to the signal strength, transmission power, bandwidth, channel, links, or privacy feature of the device 104A or 104B. In this manner, it may become more difficult to determine that the device 104C transmitted the messages 110.

The access point 102 may determine the group of devices 104A, 104B, and 104C in any manner. For example, the group may include the devices connected to the access point. As another example, the group may include the devices that rotate MAC addresses according to the same epoch duration. In some embodiments, the access point 102 may determine the group of devices 104A, 104B, and 104C using a proximity threshold. For example, devices with different usage statistics may not be as easy to distinguish from each other if the devices are far apart. As a result, the access point 102 may compare usage statistics of devices that are closer together by comparing distances between the devices to the proximity threshold. If the distance between two devices falls below the proximity threshold, then the access point 102 may group those devices for a privacy assessment.

Although generally described as an access point performing the privacy assessment, a network controller (not illustrated) that oversees multiple access points may also perform the privacy assessment and adjust the transmission characteristics of a device.

FIG. 1B illustrates an example access point 102 or device 104 of the system 100 of FIG. 1A. As seen in FIG. 1B, the access point 102 and device 104 include a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the access point 102 or the device 104. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the access point 102 or the device 104 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the access point 102 or the device 104 may use one or more of the radios 126 for Wi-Fi communications. The access point 102 or the device 104 may use one or more of the radios 126 to transmit messages and one or more of the radios 126 to receive messages. The access point 102 or the device 104 may include any number of radios 126 to communicate using any number of communication technologies.

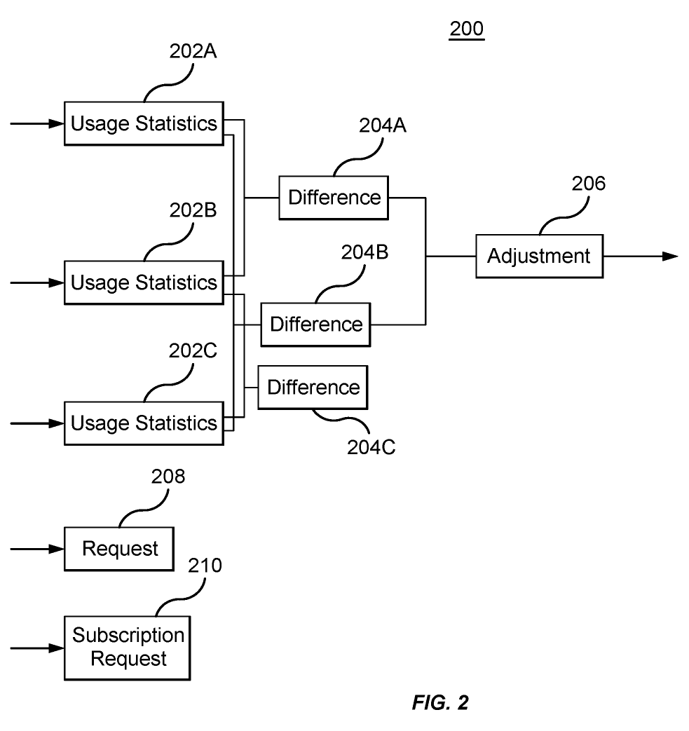

FIG. 2 illustrates an example operation 200 performed by the system 100 of FIG. 1A. An access point (e.g., the access point 102 shown in FIG. 1A) may perform the operation 200. By performing the operation 200, the access point may adjust a transmission characteristic of a device.

The access point begins by collecting or receiving usage statistics 202 from different devices. For example, the devices may report some of the usage statistics 202 to the access point. As another example, the access point may measure some of the usage statistics 202. The usage statistics 202 may include information about the transmissions of the devices. For example, the usage statistics 202 may indicate a number of devices connected to the access point. As another example, the usage statistics 202 may indicate signal strengths of the devices. As another example, the usage statistics 202 may indicate transmission powers of the devices. As another example, the usage statistics 202 may indicate bandwidths used by the devices. As another example, the usage statistics 202 may indicate channels used by the devices. As another example, the usage statistics 202 may indicate links used by the devices. As another example, the usage statistics 202 may indicate privacy features implemented by the devices. As another example, the usage statistics 202 may include the number of devices around or near each device. As another example, the usage statistics 202 may include other Layer 1 measurements. In the example of FIG. 2, the access point collects or receives the usage statistics 202A, 202B, and 202C for different devices (e.g., the devices 104A, 104B, and 104C shown in FIG. 1A, respectively).

The access point compares the usage statistics 202 to determine differences 204 between the usage statistics 202 from different devices. For example, the differences 204 may indicate differences in the signal strength, transmission power, bandwidth, channel, links, or privacy feature between the devices. In the example of FIG. 2, the access point determines a difference 204A between the usage statistics 202A and the usage statistics 202B, a difference 204B between the usage statistics 202A and the usage statistics 202C, and a difference 204C between the usage statistics 202B and the usage statistics 202C.

The access point may determine whether the differences 204 between usage statistics 202 are sufficiently large to warrant an adjustment. For example, the access point may compare the differences 204 to one or more thresholds to determine whether the differences 204 are sufficiently large. In the example of FIG. 2, the access point may determine that the differences 204A and 204B are sufficiently large. Because the differences 204A and 204B are each based on the usage statistics 202A, the access point may determine that the usage statistics 202A are sufficiently different from the usage statistics 202B and 202C to warrant an adjustment to the usage statistics 202A.

The access point may determine an adjustment 206 that adjusts a transmission characteristic of the device that produced the usage statistics 202A, which may cause the usage statistics 202A to be closer to the usage statistics 202B and 202C. For example, the adjustment 206 may change the privacy features or capabilities used by the device that produced the usage statistics 202A. As another example, the adjustment 206 may change radio properties of the device to change a signal strength, bandwidth, transmission power, channel, or link used by the device. The access point may communicate the adjustment 206 to the device to change the transmission characteristic. By communicating the adjustment 206 to the device, the access point adjusts the transmission characteristic of the device. In some embodiments, the adjustment 206 is an instruction from the access point that the device is obligated to follow. In other embodiments, the adjustment 206 is a recommendation or suggestion from the access point that the device may follow. Regardless, communicating the adjustment 206 is viewed as adjusting the transmission characteristic.

In some instances, the access point collects, receives, and compares the usage statistics in response to a request 208 from a device. For example, a device may communicate the request 208 (which may be an action frame) to the access point to request that the access point determine whether the usage statistics of the device cause transmission of the device to blend with transmissions of other devices or to be discernable or distinguishable from transmission of other devices. In response, the access point collects, receives, and compares the usage statistics of the device with the usage statistics of the other devices. The access point may then adjust the transmission characteristic of the device if the usage statistics of the device are sufficiently different from the usage statistics of the other devices.

In some embodiments, the request 208 indicates other information about the device. For example, the request 208 may include some of the usage statistics for the device. The request 208 may indicate whether or not the device is using certain privacy features, such as rotating MAC addresses according to an epoch duration for the group of devices connected to the access point. If the device is not rotating MAC addresses according to the epoch duration for the group, then it may be beneficial for the usage statistics of the device to be brought closer to the usage statistics of the other devices.

The access point may also make other determination to determine whether the transmission characteristic should be adjusted. For example, the access point may evaluate the traffic from a device to determine whether the device is leaking personally identifiable information or other confidential information. If the device is leaking this information, the access point may adjust the transmission characteristics of the device so that it becomes more difficult to trace the information to the device.

In certain embodiments, the access point collects, receives, and compares the usage statistics based on a subscription request 210 from a device. The device may use the subscription request to request that the access point periodically assess the privacy of the device by comparing the usage statistics of the device with the usage statistics of a group of devices connected to the access point or within a proximity threshold of the device. The subscription request 210 may indicate a periodicity or frequency of the privacy assessment. The access point may then periodically collect, receive, and compare the usage statistics of the device with the usage statistics of the group of devices. The access point may then adjust a transmission characteristic of the device to bring the usage statistics of the device closer to the usage statistics of the group of devices.

In some instances, the subscription request 210 may establish a telemetry subscription in which the access points transmits async frames when the access point determines that the privacy of the device is at risk. This subscription may take the form of a capability bit activated at association or added to an existing frame (e.g. STA_specific epoch setting request), or of a specific action frame query (for example after the devices changes groups).

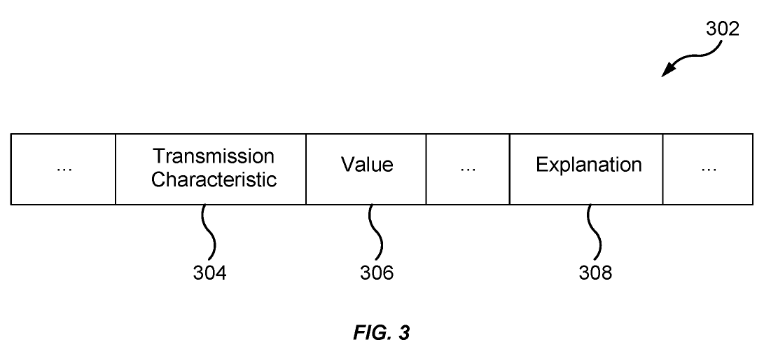

FIG. 3 illustrates an example adjustment 302 in the system 100 of FIG. 1A. An access point (e.g., the access point 102 shown in FIG. 1A) may transmit (e.g., wirelessly transmit) the adjustment 302 to adjust a transmission characteristic of a device.

As seen in FIG. 3, the adjustment 302 includes a field 304 that identifies a transmission characteristic, which may be the transmission characteristic that is to be adjusted. The adjustment 302 or the field 304 may identify any number of transmission characteristics to be adjusted. For example, the adjustment 302 or the field 304 may identify a privacy feature or a radio parameter (e.g., a transmission frequency, a number of spatial streams, a transmission power, a channel or link to use, etc.).

The adjustment 302 also includes a field 306 that indicates a value for the transmission characteristic. The value may be the value to which the transmission characteristic should be adjusted. When a device receives the adjustment 302, the device may adjust the transmission characteristic to the indicated value, which may bring the usage statistics of the device closer to the usage statistics of other devices connected to the access point or near the device.

The adjustment 302 may also include a field 308 that includes an explanation for why the transmission characteristic should be adjusted. The explanation may include the usage statistics of the device and the usage statistics of other devices, which may show the similarities in usage statistics. For example, the explanation may explain that the device uses the 80 megaHertz (MHz) frequency and 92% of other devices use the 40 MHz frequency. As another example, the explanation may explain that the device uses three spatial streams while 100% of other devices use one or two spatial streams. Additionally or alternatively, to protect the privacy of other devices, the explanation may include ranges for the number of devices that have different usage statistics. For example, the explanation may explain that there are between six to ten other devices with different usage statistics.

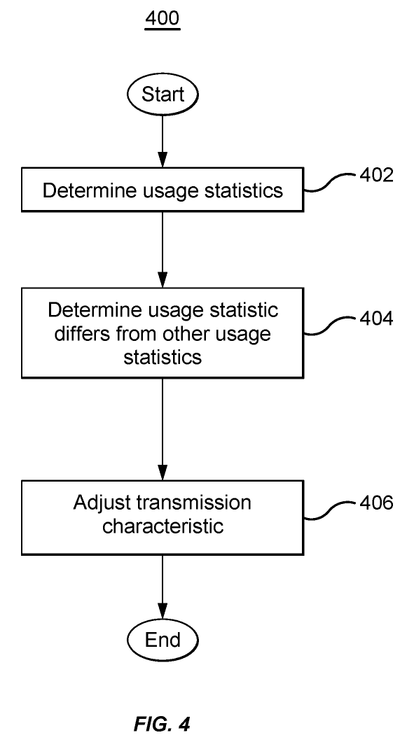

FIG. 4 is a flowchart of an example method 400 performed by the system 100 of FIG. 1A. In certain embodiments, an access point (e.g., the access point 102 shown in FIG. 1A) performs the method 400. By performing the method 400, the access point adjusts a transmission characteristic of a device to improve the privacy of the device.

At 402, the access point determines usage statistics of a group of devices (e.g., a group of devices connected to the access point or a group of devices that are in close proximity to each other). The usage statistics may indicate various properties of the wireless use of the devices. For example, the usage statistics may indicate privacy features implemented by the devices, signal strengths of the devices, bandwidths used by the devices, transmission powers of the devices, channels used by the devices, links used by the devices, etc. The access point may receive some of the usage statistics from the devices, or the access point may measure some of the usage statistics.

At 404, the access point determines whether the usage statistics of a device difference from usage statistics of other devices in the group. For example, the access point may determine differences between the usage statistics of the device and the usage statistics of other devices. The access point may compare these differences to one or more thresholds. If the differences exceed the thresholds, then the access point may determine that the differences are sufficiently large that the transmissions from the device may be distinguishable or discernable from the transmissions of the other devices.

At 406, the access point adjusts a transmission characteristic of the device. For example, the access point may adjust a privacy feature or radio parameter of the device. The access point may transmit the adjustment to the transmission characteristic to the device to adjust the transmission characteristic. By adjusting the transmission characteristic, the usage statistics for the device may be brought closer to the usage statistics of the other devices in the group, which may make it more difficult to distinguish or discern the transmissions made by the device.

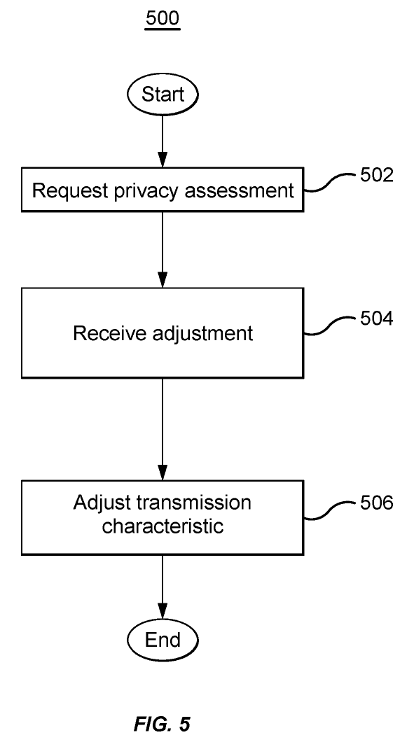

FIG. 5 is a flowchart of an example method 500 performed by the system 100 of FIG. 1A. In some embodiments, a device (e.g., the device 104C shown in FIG. 1A) performs the method 500. By performing the method 500, the device may adjust a transmission characteristic, which may bring the usage statistics of the device closer to the usage statistics of other devices (e.g., other devices connected to the same access point or other devices near the device).

At 502, the device may request a privacy assessment from an access point. The device may communicate a request to the access point, and in response, the access point may assess whether the usage statistics of the device are sufficiently different from the usage statistics of the other devices. In some instances, the device may communicate a subscription request to the access point so that the access point periodically assesses the usage statistics of the device relative to the other devices.

At 504, the device receives an adjustment from the access point. The adjustment may indicate a transmission characteristic (e.g., a privacy feature or radio parameter) of the device that should be adjusted as well as the adjustment to the transmission characteristic. In some instances, the adjustment may also provide an explanation for why the adjustment should be made.

At 506, the device adjusts the transmission characteristic in the adjustment received from the access point. By adjusting the transmission characteristic, the usage statistics of the device may be brought closer to the usage statistics of the other devices. For example, the device may begin using privacy features that the other devices use or use the privacy features in a similar manner as the other devices. As another example, the device may begin having the signal strength as the other devices. As another example, the device may use frequencies, bandwidths, transmission powers, channels, links, etc. that are similar to those used by the other devices. In this manner, it may be more difficult to distinguish the transmissions of the device from the transmissions of the other devices.

In summary, a network determines whether the transmission characteristics of a device distinguish the device from other devices on the network. For example, an access point 102 in the network may receive and analyze usage statistics of multiple devices on the network. These usage statistics may indicate the number of devices, the capabilities of the devices, the privacy features used by the devices, the signal strength of the devices, the bandwidth of the devices, the transmission powers of the devices, the channels used by the devices, the number of links used by the devices, etc. The access point 102 may determine whether the usage statistics of a device are sufficiently different from the usage statistics of a large number of other devices such that the usage statistics of the device may reveal or distinguish the transmissions of the device from the transmissions of the other devices. The access point 102 may then adjust the transmission characteristics of the device such that the usage statistics of the device are brought closer to the usage statistics of the other devices.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An apparatus comprising:
one or more memories; and
one or more processors communicatively coupled to the one or more memories, the one or more processors configured to, individually or collectively, perform an operation comprising:
determining usage statistics of a wireless medium for a group of user devices;
determining that a first usage statistic of the usage statistics for a first user device of the group of user devices differs from a usage statistic of the usage statistics for other user devices of the group of user devices; and
based on determining that the first usage statistic differs from the usage statistic for the other user devices, adjusting a transmission characteristic of the first user device such that the first usage statistics are brought closer to the usage statistics for the other user devices.

2. The apparatus of claim 1, wherein the operation further comprises receiving, from the first user device, a request for an indication of wireless transmissions from the first user device blending with wireless transmissions of the other user devices and wherein determining that the first usage statistics differs from the usage statistics for the other user devices is based on the request.

3. The apparatus of claim 2, wherein the request indicates that the first user device is refraining from rotating a media access control address of the first user device according to an epoch duration for the group of user devices.

4. The apparatus of claim 1, wherein the first usage statistics differing from the usage statistic for the other user devices allows wireless transmissions of the first user device to be discernable from wireless transmissions of the other user devices.

5. The apparatus of claim 1, wherein adjusting the transmission characteristic of the first user device comprises wirelessly transmitting, to the first user device, the first usage statistic and the usage statistic for the other user devices.

6. The apparatus of claim 1, wherein adjusting the transmission characteristic of the first user device comprises wirelessly transmitting, to the first user device, a range for a number of user devices in the other user devices.

7. The apparatus of claim 1, wherein the transmission characteristic comprises at least one of a transmission frequency of the first user device or a number of spatial streams used by the first user device.

8. The apparatus of claim 1, wherein the group of user devices comprises user devices within a proximity threshold.

9. A method comprising:
determining usage statistics of a wireless medium for a group of user devices;
determining that a first usage statistic of the usage statistics for a first user device of the group of user devices differs from a usage statistic of the usage statistics for other user devices of the group of user devices; and
based on determining that the first usage statistic differs from the usage statistic for the other user devices, adjusting a transmission characteristic of the first user device such that the first usage statistics are brought closer to the usage statistics for the other user devices.

10. The method of claim 9, further comprising receiving, from the first user device, a request for an indication of wireless transmissions from the first user device blending with wireless transmissions of the other user devices and wherein determining that the first usage statistics differs from the usage statistics for the other user devices is based on the request.

11. The method of claim 10, wherein the request indicates that the first user device is refraining from rotating a media access control address of the first user device according to an epoch duration for the group of user devices.

12. The method of claim 9, wherein the first usage statistics differing from the usage statistic for the other user devices allows wireless transmissions of the first user device to be discernable from wireless transmissions of the other user devices.

13. The method of claim 9, wherein adjusting the transmission characteristic of the first user device comprises wirelessly transmitting, to the first user device, the first usage statistic and the usage statistic for the other user devices.

14. The method of claim 9, wherein adjusting the transmission characteristic of the first user device comprises wirelessly transmitting, to the first user device, a range for a number of user devices in the other user devices.

15. The method of claim 9, wherein the transmission characteristic comprises at least one of a transmission frequency of the first user device or a number of spatial streams used by the first user device.

16. The method of claim 9, wherein the group of user devices comprises user devices within a proximity threshold.

17. A non-transitory computer readable medium storing instructions that, when executed by one or more processors, cause the one or more processors to, individually or collectively, perform an operation comprising:
determining usage statistics of a wireless medium for a group of user devices;
determining that a first usage statistic of the usage statistics for a first user device of the group of user devices differs from a usage statistic of the usage statistics for other user devices of the group of user devices; and
based on determining that the first usage statistic differs from the usage statistic for the other user devices, adjusting a transmission characteristic of the first user device such that the first usage statistics are brought closer to the usage statistics for the other user devices.

18. The medium of claim 17, wherein the operation further comprises receiving, from the first user device, a request for an indication of wireless transmissions from the first user device blending with wireless transmissions of the other user devices and wherein determining that the first usage statistics differs from the usage statistics for the other user devices is based on the request.

19. The medium of claim 17, wherein the first usage statistics differing from the usage statistic for the other user devices allows wireless transmissions of the first user device to be discernable from wireless transmissions of the other user devices.

20. The medium of claim 19, wherein adjusting the transmission characteristic of the first user device comprises wirelessly transmitting, to the first user device, the first usage statistic and the usage statistic for the other user devices.
